(19) United States
(12) Patent Application Publication
(10) Pub. No.: US 2007/0213059 A1
(43) Pub. Date: Sep. 13, 2007

(54) WIRELESS COMMUNICATION METHOD AND SYSTEM FOR PERFORMING HANDOVER BETWEEN TWO RADIO ACCESS TECHNOLOGIES

(75) Inventor: Kamel M. Shaheen, King of Prussia, PA (US)

Correspondence Address: VOLPE AND KOENIG, P.C.;DEPT. ICC, UNITED PLAZA, SUITE 1600, 30 SOUTH 17TH STREET, PHILADELPHIA, PA, 19103, US

(73) Assignee: INTERDIGITAL TECHNOLOGY CORPORATION, Wilmington, DE (US)

(21) Appl. No.: 11/683,037

(22) Filed: Mar. 7, 2007

Related U.S. Application Data
(60) Provisional application No. 60/780,582, filed on Mar. 9, 2006.

(51) Int. Cl. H04Q 7/20

(52) U.S. Cl. 455/436

(57) ABSTRACT

The present invention relates to a method and apparatus for performing handover between a universal mobile telecommunication system (UMTS) terrestrial radio access network (UTRAN), and an evolved-UTRAN (E-UTRAN) based system. The wireless communication system includes a UTRAN, an E-UTRAN, a 2G/3G core network, and long term evolution (LTE) core network, and at least one wireless transmit/receive unit (WTRU) including an LTE element and ad 2G/3G element. According to the present invention the WTRU shall be able to handover a call initiated on the UTRAN to the E-UTRAN, and visa versa. The 2G/3G core network and the LTE core network are linked by a Gn interface.

### CROSS REFERENCE TO RELATED APPLICATION

This application claims the benefit of Provisional Application No. 60/780,582 filed on Mar. 9, 2006, which is incorporated by reference as if fully set forth.

### FIELD OF INVENTION

The present invention relates to wireless communication systems. In particular, the present invention relates to a method and apparatus for supporting handover between a second-generation (2G)/third-generation (3G) radio access network (RAN) and an evolved-universal mobile telecommunication system (UMTS) terrestrial radio access network (E-UTRAN) based system.

### BACKGROUND

As 3G and Long Term Evolution (LTE) technology is widely introduced, one key consideration is the need for continuing to provide service using older 2/2.5G technologies as well as 3G and LTE technologies in a seamless fashion. However, it will take some time before the geographical coverage and network capacity of 3G and LTE based networks will match that achieved by older 2/2.5G networks. Also the nature of 3G and LTE systems may mandate different footprints within the same coverage area, for example, LTE cells may be smaller than that of 3G and 2/2.5G technologies.

Where 3G or LTE coverage is absent, the user will need to utilize the older 2/2.5G networks, and wireless transmit/receive units (WTRUs) operating in the networks will require the support of multiple radio access technologies (RATs), thus requiring a multi-RAT WTRU capability. Not only must the multi-RAT WTRUs be capable of searching for other types of RAT networks at power-up, but the multi-RAT WTRUs must also be capable of re-selecting the network type when moving out of the LTE coverage area.

During an inter-RAT handover, the call/session must be handed over from one RAT network to another without any significant degradation of performance noticeable to the user of a dual-RAT WTRU. For general packet radio service (GPRS) capable multi-RAT WTRUs, the packet service connection must also be transferred to another network.

Intersystem handover is a process of maintaining a communication connection while moving from one cell of a first RAT network to another cell of a second RAT network. As LTE networks are deployed in geographical areas overlapping older 2G/2.5G networks, seamless inter-RAT handover will become critical to providing users with uninterrupted service and reachablility. Therefore, inter-RAT handover techniques that do not affect a WTRU's performance are desired.

### SUMMARY

The present invention relates to a method and apparatus for performing handover between a UTRAN and an E-UTRAN in a wireless communication system. The wireless communication system includes a UTRAN, an E-UTRAN, a 2G/3G core network, and LTE core network, and at least one WTRU including an LTE element and ad 2G/3G element. According to the present invention, the WTRU is configured to handover a call initiated on the UTRAN to the E-UTRAN, and visa versa.

The E-UTRAN based system comprises an access gateway (AGW) located in the LTE core network which may initiate a handover procedure for the WTRU to switch from an E-UTRAN mode to the UTRAN mode. The handover procedure may be initiated in response to a measurement report sent by the WTRU to the AGW. Upon initiating handover, the AGW exchanges messages with an access server gateway (ASGW) anchor node located in the LTE core network. Then the ASGW exchanges messages with a target SGSN located in the target 2G/3G network over a Gn interface. The Gn interface is an existing protocol that is IP based to connect between SGSNs and SGSN-GGSN. Upon receipt of a handover message from the ASGW, the target SGSN notifies a target radio network controller (RNC). The target RNC then notifies a target node B. The target RNC then sends the WTRU a handover command through the SGSN, the ASGW, the AGW and the LTE NB. The handover command includes a target cell ID and channel. Once the WTRU receives the handover command, the WTRU switches channels and establishes a radio link with the target node B on the new channel in a UTRAN mode. The target node B then notifies the RNC that the handover is complete. The RNC forwards the handover complete message to the ASGW by way of the SGSN, and the ASGW instructs the AGW to release the E-UTRAN radio resources the WTRU was previous using.

### BRIEF DESCRIPTION OF THE DRAWINGS

A more detailed understanding of the invention may be had from the following description of a preferred embodiment, given by way of example and to be understood in conjunction with the accompanying drawings wherein:

FIG. 1 is an exemplary block diagram of an dual mode communication system that is configured in accordance with the present invention;

FIG. 2 shows signaling between the components of the system of FIG. 1 performing a handover process from E-UTRAN to UTRAN; and

FIG. 3 shows signaling between the components of the system of FIG. 1 performing a handover process from UTRAN to E-UTRAN.

### DETAILED DESCRIPTION OF THE PREFERRED EMBODIMENT(S)

When referred to hereafter, the terminology “wireless transmit/receive unit (WTRU)” includes but is not limited to a user equipment (UE), a mobile station, a fixed or mobile subscriber unit, a pager, a cellular telephone, a personal digital assistant (PDA), a computer, or any other type of user device capable of operating in a wireless environment. When referred to hereafter, the terminology “base station” includes but is not limited to a Node-B, a site controller, an access point (AP), or any other type of interfacing device capable of operating in a wireless environment.

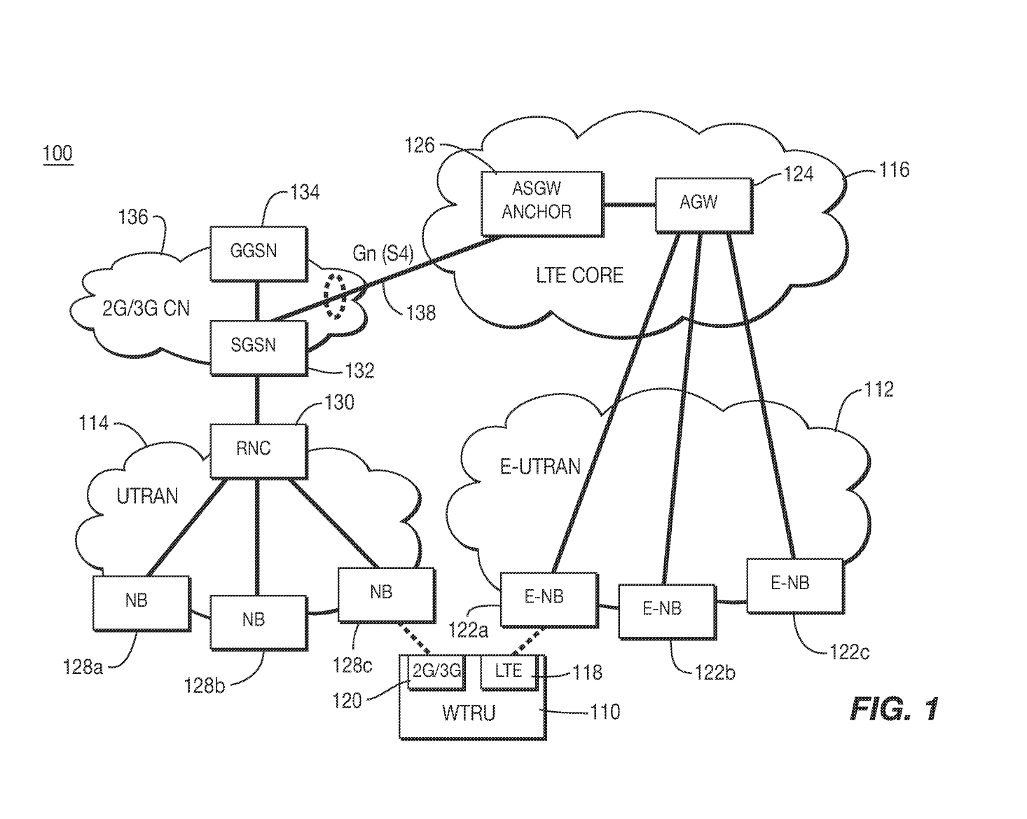

FIG. 1 is an exemplary block diagram of a wireless communication system 100 including both LTE and 2G/3G components. The system includes at least one multi-RAT WTRU 110, an E-UTRAN 112, a U-TRAN 114, an LTE core network 116, and a 2G/3G core network 136.

The WTRU 110 is configured for handover between the UTRAN 114 and the E-UTRAN 112, and visa versa, according to the present invention. The WTRU 110 includes an LTE element 118, and a 2G/3G element 120. The WTRU 110 operates in either an LTE mode, or a 2G/3G mode.

Typically, when the WTRU 100 operates in the LTE mode, the WTRU 100 exchanges messages with the E-UTRAN 112 via the LTE element 118 and an enhanced-Node B (E-NB) 122, and the E-NB 122 exchanges messages with an access gateway (AGW) 124 located in the LTE core network 116. The AGW 124 communicates with the access server gateway (ASGW) anchor node 126.

When the WTRU 110 operates in 2G/3G mode, the WTRU 110 exchanges messages with the UTRAN 114 via the 2G/3G element 120 and a node B (NB) 128, and the NB 128 exchanges messages with an radio network controller (RNC) 130. The UTRAN 114 exchanges messages with the 2G/3G core network 136 via the RNC 130 and the SGSN 132. When the WTRU 110 is operating in 2G/3G mode, the SGSN 132 keeps track of the location of the WTRU 110.

The 2G/3G core network 136 also includes a GGSN 134. The GGSN 134 is a gateway function in the 2G/3G system 136. It allocates the IP addresses and connects the user to desired service servers. The GGSN 134 also controls the Quality of Service (QoS) of the various data flows and connects the wireless system to the IP multimedia subsystems (IMS) system. The 2G/3G core network 136 communicates with the LTE core network 116 through the ASGW anchor node 126 and the SGSN 132. The ASGW anchor node 126 and the SGSN exchange messages over a GN (s4) communication link 138.

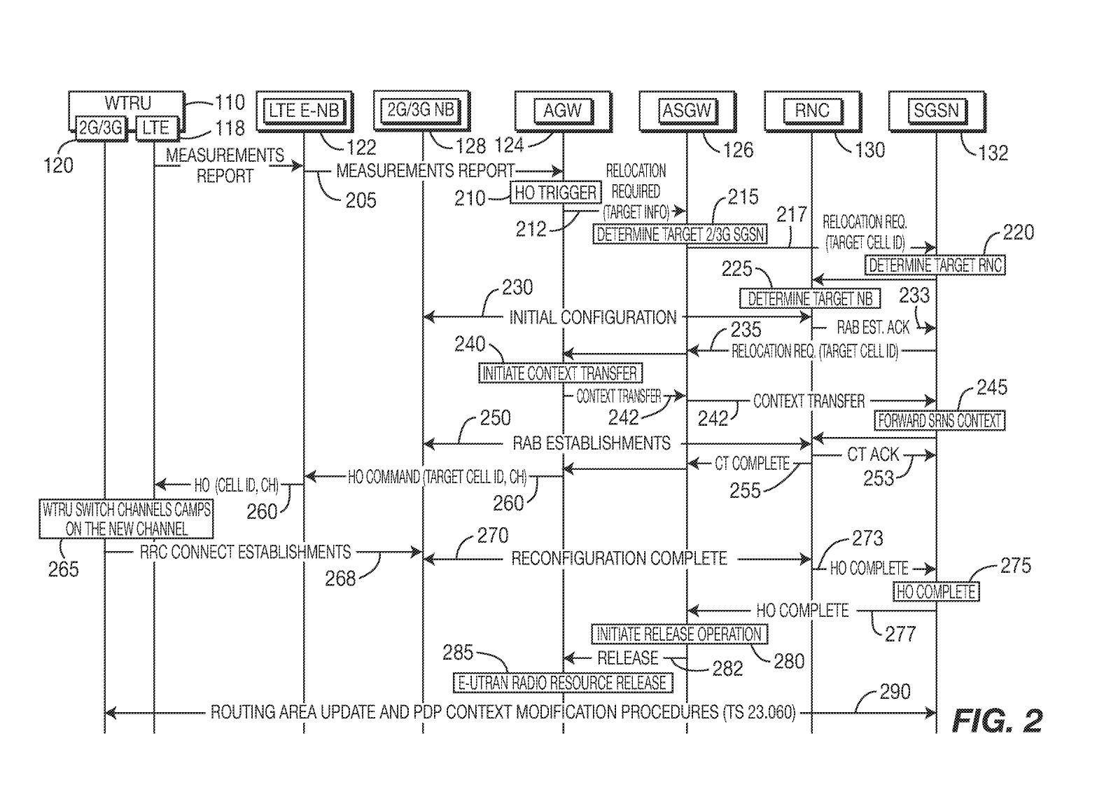

FIG. 2 shows signaling between the components of the system 100 of FIG. 1 in accordance with the present invention. Specifically, FIG. 2 shows a procedure for handover from an LTE mode of communication to a 2G/3G mode of communication.

In the E-UTRAN to UTRAN handover procedure of FIG. 2, the WTRU 110 is initially operating in an LTE mode, and sends a measurement report 205 to the AGW 124 by way of the E-NB 122. At step 210, the AGW 124 triggers a hand off procedure based on information contained in the measurement report 205 and sends a relocation request message 217 containing target information to the ASGW 126 including target cell ID and target SGSN.

At step 215, the ASGW 126 sends a relocation request message 217 containing information related to the target cell ID to the target SGSN 132. At step 220, the target SGSN 132 determines a target RNC 130 and then signals the target RNC 130. At step 225, the target RNC 130 determines a target NB 128 and the target RNC 130 exchanges initial configuration messages with the target NB 128. After the initial configuration messages have been exchanged, the target RNC 130 sends a radio access bearer (RAB) establishment acknowledgement 233 to the target SGSN 132.

At step 235, the target SGSN sends a relocation request to the AGW 124 by way of the ASGW 126. The relocation request includes the target Cell ID. At step 240, the AGW initiates context transfer (CT) by sending a context transfer message 242 to the target SGSN 132 by way of the ASGW 126. At step 245, the target SGSN 132 forwards the SRNS context to the target RNC 130. At step 250 the target RNC 130 and the target 2G/3G NB 128 exchange RAB establishment messages. Next, the target RNC 130 sends a CT complete message 255 to the AGW 124 by way of the ASGW 126, and the target RNC 130 also sends a CT acknowledgment 253 to the target SGSN 132. At step 260, the AGW 124 forwards a handover command to the WTRU 110 by way of the E-NB 122, specifying the Cell ID, and the channel number (CH).

At step 265, the WTRU 110 switches channels and camps on the new channel specified in the handover command. At step 268, the WTRU sends an RRC connect establishment message to the 2G/3G NB 128 on the new channel using the 2G/3G element 120. At step 270, the 2G/3G NB 128 and the target RNC 130 exchange reconfiguration complete messages. At step 273, the target RNC 130 sends a handover complete message to the target SGSN 132. At step 275, the target SGSN completes the handover by sending a handover complete message 277 to the ASGW 126.

At step 280, the ASGW initiates a release operation by sending a release message 282 to the AGW 124. At step 285, the E-UTRAN radio resource is released. The handover is completed at step 290 where the WTRU 110 and the SGSN 132 exchange routing area (RA) update and PDP context modification procedures.

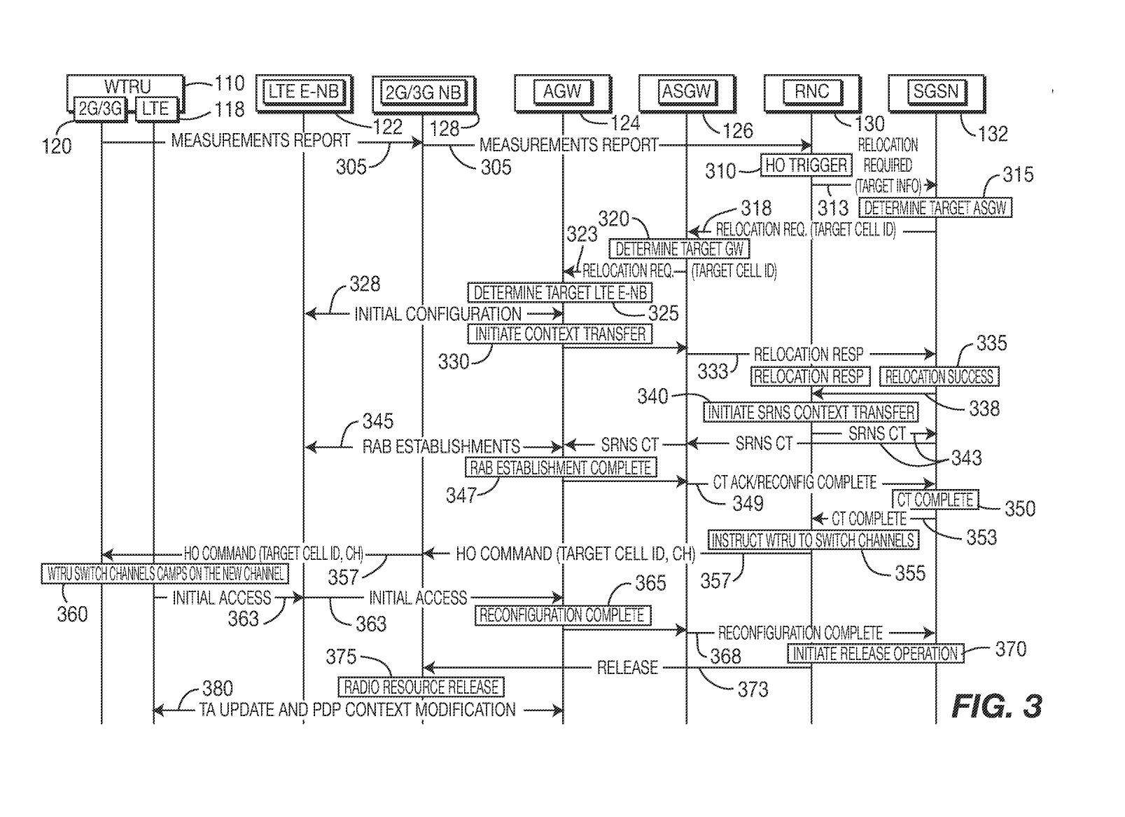

FIG. 3 shows signaling between the components of the system 100 of FIG. 1 in accordance with the present invention. Specifically, FIG. 3 shows a procedure for handover from a 2G/3G mode of communication to an LTE mode of communication.

In the UTRAN to E-UTRAN handover procedure of FIG. 3, the WTRU 110 initially operates in a 2G/3G mode. The WTRU 110 sends a measurement report 305 to the RNC 130 by way of the NB 122. At step 310, the RNC 130 triggers a handover based on information contained in the measurement report and sends a relocation required message 313 containing target information to the SGSN 132. At step 315, the SGSN determines a target ASGW and sends the target ASGW 126 a relocation required message 318, the relocation required message 318 including a target cell ID. At step 320, the target ASGW 126 determines a target AGW and forwards the target AGW 124 a relocation required message 318. At step 325, the target AGW 124 determines a target E-NB. At step 328, the target AGW 124 and the Target E-NB 122 exchange initial configuration messages.

At step 330, the AGW initiates context transfer (CT) by sending a relocation response message 333 to the SGSN 132 by way of the target ASGW 126. At step 335 the SGSN 132 sends a relocation success message to the RNC 130. At step 340, the RNC initiates a SRNS context transfer by sending a SRNS context message 343 to the target AGW 124, by way of the SGSN 132 and the target ASGW 126. At step 345, the target AGW and the target E-NB 122 exchange RAB establishment messages. At step 347, the RAB establishment is completed and the target AGW 124 sends a context acknowledgment and reconfiguration complete message 349 to the SGSN 132 through the target ASGW 126. At step 350, the CT is complete and the SGSN 132 sends a CT complete message 353 to the RNC 130.

At step 355, the RNC 130 instructs the WTRU to switch channels by sending a handover command 357 to the WTRU 110 by way of the 2G/3G NB 128. The handover command message 357 includes at least a target cell ID and a channel. At step 360, the WTRU 110 switches channels and camps on the new channel. At step 363, the E-NB 122 sends an initial access message to the target AGW 124 using E-UTRAN resources. At step 365, the reconfiguration is complete and the target AGW 124 sends a reconfiguration complete message 368 to the SGSN 132 by way of the ASGW. At step 370, the RNC initiates a release operation by sending a release message 373 to the 2G/3G NB. At step 375, the radio resources are released at the 2G/3G NB 128. At step 380, the WTRU 110 sends the target AGW 124 a RA update and packet data protocol (PDP) context modification message.

Although the features and elements of the present invention are described in the preferred embodiments in particular combinations, each feature or element can be used alone without the other features and elements of the preferred embodiments or in various combinations with or without other features and elements of the present invention. The methods or flow charts provided in the present invention may be implemented in a computer program, software, or firmware tangibly embodied in a computer-readable storage medium for execution by a general purpose computer or a processor. Examples of computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine.

A processor in association with software may be used to implement a radio frequency transceiver for use in a wireless transmit receive unit (WTRU), user equipment (UE), terminal, base station, radio network controller (RNC), or any host computer. The WTRU may be used in conjunction with modules, implemented in hardware and/or software, such as a camera, a video camera module, a videophone, a speakerphone, a vibration device, a speaker, a microphone, a television transceiver, a hands free headset, a keyboard, a Bluetooth® module, a frequency modulated (FM) radio unit, a liquid crystal display (LCD) display unit, an organic light-emitting diode (OLED) display unit, a digital music player, a media player, a video game player module, an Internet browser, and/or any wireless local area network (WLAN) module.

What is claimed is:

1. In a wireless communication system, including a dual radio access technology (RAT) wireless transmit/receive unit (WTRU), a universal mobile telecommunication system (UMTS) terrestrial radio access network (UTRAN), an evolved-UTRAN (E-UTRAN), a 2^{nd} generation/3^{rd} generation (2G/3G) core network, and a long term evolution (LTE) network, a method of performing handover of the WTRU from E-UTRAN to UTRAN, the method comprising:
initiating a handover process, at an access gateway (AGW) based on the measurement reports sent by the WTRU;
sending a relocation request from the AGW to a target radio network controller located in the target UTRAN;
allocating resources for the WTRU in the target UTRAN;
sending a relocation response from the UTRAN to the AGW;
sending a handover command from the AGW to the WTRU;
performing an Serving Radio Network Subsystem (SRNS) relocation by sending SRNS context to the target RNC;
sending a reconfiguration complete message from the WTRU to a target serving general packet radio service (GPRS) Support Node (SGSN);
releasing the radio resources on the E-UTRAN by sending a release message to the to the E-UTRAN; and
sending an update packet data protocol (PDP) context from the target SGSN to an access server gateway (ASGW) anchor node.

2. The method of claim 1 wherein the relocation request is sent from the AGW to the target RNC via the ASGW anchor node and the SGSN.

3. The method of claim 2 wherein the ASGW acts as a source SGSN.

4. The method of claim 1 wherein allocating resources in for the WTRU in the target UTRAN includes allocating resources in the target SGSN.

5. The method of claim 1 wherein the relocation response message is sent from the UTRAN to the AGW via the ASGW anchor node.

6. The method of claim 1 wherein the handover command includes information relating to the radio access technology, channel number, routing area and location area for a new connection.

7. The method of claim 1 wherein the SRNS context message is setn tot eh target RNC via the ASGW.

8. The method of claim 1 wherein sending the update PDP context message includes updating the Qos profile.

9. The method of claim 1 wherein sending the update PDP context message includes updating the home subscriber service (HSS).

10. The method of claim 1 wherein the ASGW and the SGSN communicate over the Gn interface.

11. In a wireless communication system, including a dual radio access technology (RAT) wireless transmit/receive unit (WTRU), a universal mobile telecommunication system (UMTS) terrestrial radio access network (UTRAN), an evolved-UTRAN (E-UTRAN), a 2^{nd} generation/3^{rd} generation (2G/3G) core network, and a long term evolution (LTE) network, a method of performing handover of the WTRU from UTRAN to E-UTRAN, the method comprising:
triggering handover at an radio network controller based on measurements received from the WTRU;
determining a target evolved-node B (E-NB);
initiating a context transfer at a target access gateway (AGW);
allocating the radio resources needed for the WTRU in the E-UTRAN;
sending a handover command to the WTRU;
switching channels in the WTRU in response to the handover command;
sending a initial access message to the target AGW from the WTRU;
initiating a release operation in a serving general packet radio service (GPRS) Support Node (SGSN) to release the radio resources used by the WTRU; and
updating the a packet data protocol (PDP) context information with the target AGW.

12. The method of claim 11 wherein the determining a target E-NB includes determining a target access server gateway node ASGW anchor node.

13. The method of claim 11 wherein determining a target E-NB includes determining a target ASG.

14. The method of claim 11 wherein the handover command includes information relating to radio access technology, channel number, routing area and location area.

15. The method of claim 11 wherein the ASGW and the SGSN communicate over a Gn interface.

16. A wireless communication system for performing handover of a wireless transmit/receive unit between a universal mobile telecommunication system (UMTS) terrestrial radio access network (UTRAN), and an evolved-UTRAN (E-UTRAN), the system comprising:
a dual radio access technology (RAT) WTRU;
a 2^{nd} generation/3^{rd} generation (2G/3G) core network including an serving gateway support node (SGSN);
a UTRAN linked to the 2G/3G core network via the SGSN;
a long term evolution (LTE) network including a an access server gateway (ASGW) anchor node;
an E-UTRAN linked the to LTE core network via ASGW anchor node; wherein the SGSN and the ASGW are communicate via an existing Gn interface.

17. The system of claim 16 wherein the UTRAN includes at least on radio network controller for communicating with a node B and the SGSN, and for triggering an handover from UTRAN to E-UTRan based on measurements received from the WTRU.

18. The system of claim 17 wherein the WTRU exchanges messages with the node B when the WTRU is operating in a 2G/3G mode.

19. The system of claim 16 wherein the LTE core network includes an access gateway (AGW) for communicating between at least one evolved—Node B (E-NB) and the ASGW anchor node and for triggering a handover from E-UTRAN to the UTRAN based on measurements received from the WTRU.

20. The system of claim 19 wherein the WTRU exchanges messages with the E-NB when the WTRU is operating in LTE mode.

21. A dual mode wireless transmit/receive unit (WTRU) configured for performing handover between a long term evolution (LTE) network and second generation/third generation (2G/3G) network, the WTRU comprising:
an LTE element for communicating with a LTE core network; and
a 2G/3G element for communicating with a 2G/3G core network, wherein the LTE core network and the 2G/3G network communicate over a Gn interface.

22. The WTRU of claim 21 wherein the LTE element communicates with the LTE core network through and evolved node b (E-NB) located in an evolved universal mobile telecommunication system (UMTS) terrestrial radio access network (E-UTRAN).

23. The WTRU of claim 22 wherein the E-NB communicates with the LTE core network through an access gateway (AGW).

24. The WTRU of claim 23 wherein the AGW communicates is linked to the Gn interface through the access server gateway (ASGW) anchor node.

25. The WTRU of claim 21 wherein the 2G/3G element communicates with the LTE with a node B (NB) located in the universal mobile telecommunication system (UMTS) terrestrial radio access network (UTRAN).

26. The WTRU of claim 21 wherein the NB communicates with the 2G/3G core network through the serving gateway support node (SGSN) located in the 2G/3G network.

27. The WTRU of claim 21 wherein the SGSN is linked to the Gn interface.
